(19) United States
(12) Patent Application Publication
(10) Pub. No.: US 2010/0170275 A1
(43) Pub. Date: Jul. 8, 2010

(54) COOLING STATION FOR RECEIVING A FRAME

(75) Inventors: Claus Konrad, Kampfelbach (DE); Peter Wirth, Eppingen (DE); Ralf Böss, Kraichtal (DE)

Correspondence Address: HANLEY, FLIGHT & ZIMMERMAN, LLC, 150 S. WACKER DRIVE, SUITE 2100, CHICAGO, IL, 60606, US

(73) Assignee: BLANCO CS GMBH + CO KG, Oberderdingen (DE)

(21) Appl. No.: 12/398,835

(22) Filed: Mar. 5, 2009

Related U.S. Application Data
(63) Continuation of application No. PCT/EP2007/007935, filed on Sep. 12, 2007.

(30) Foreign Application Priority Data
Sep. 22, 2006 (DE) 102006044844.8

(51) Int. Cl. F25D 31/00; F25D 17/06; F25D 3/06; A23B 4/06; A47F 5/00; A47F 7/00

(52) U.S. Cl. 62/259.1; 62/426; 62/425; 99/476; 211/71.01; 211/85.4; 211/85.8

(57) ABSTRACT

In order to provide a device, which with a low outlay enables a product to be cooled to be conveyed to a place of use and cooled reliably and energy-efficiently at the place of use, a cooling station for receiving a frame that has receivers for a product to be cooled is proposed, wherein the cooling station comprises at least one fan for generating a circulating air flow through the frame and at least one cooler for cooling the circulating air flow and wherein the cooling station comprises a housing that surrounds a receiving space for receiving the frame on at least three sides.

### RELATED APPLICATION

This application is a continuation application of PCT/EP2007/007935 filed Sep. 12, 2007, the entire specification of which is incorporated herein by reference.

### FIELD OF DISCLOSURE

The present invention relates to the technical field of the cooling of products to be cooled.

### BACKGROUND

For the portioning of food in institutional catering it is known to use thermally insulated, actively cooled food-conveying trolleys, from which cooled food and/or drinks may be removed for portioning onto trays. Because of the integrated refrigerating unit, such conveying trolleys with active cooling are of a complicated construction and expensive to manufacture, take up a lot of room and are very heavy. What is more, protecting the integrated electrical components from the liquid used for cleaning entails a high outlay.

For portioning food it is further known to use mobile rack trolleys without a cooling device, which are moved from a refrigerator room to a point alongside a food conveyor belt where the cooled product accommodated on the rack trolley is then portioned onto trays. In this case, in order to keep the cooled product cool flexible hoods may be used, which at least partially prevent an exchange of air with the environment.

Such rack trolleys without cooling have to be used in a cooled environment to guarantee an uninterrupted cooling chain for the food distribution. Working in a cooled environment does however place increased strain on the operating personnel and moreover entails a high expenditure of energy since very large spaces have to be cooled.

### SUMMARY OF THE INVENTION

The underlying object of the invention is to provide a device, which with a low outlay enables a product to be cooled to be conveyed to a place of use and cooled reliably and energy-efficiently at the place of use.

This object is achieved according to the invention by means of a cooling station for receiving a frame that has receivers for a product to be cooled, wherein the cooling station comprises at least one fan for generating a circulating air flow through the frame and at least one cooler for cooling the circulating air flow and wherein the cooling station comprises a housing that surrounds a receiving space for receiving the frame on at least three sides.

The frame accommodated in the receiving space is screened off from the warmer environment on at least three sides, for example the left, the rear and the right, by the housing of the cooling station so that the product to be cooled is protected from an addition of heat from the warmer environment.

The cooled circulating air flow that passes through the frame with the product to be cooled accommodated thereon forms a cold-air curtain above and through the frame that screens off the product to be cooled from the warmer environment on the remaining sides.

On the sides screened off by means of the cold-air curtain the frame with the product to be cooled accommodated thereon is freely accessible, thereby allowing an ergonomic operation and easy removal of the cooled product from the frame.

The frame for receiving the product to be cooled performs only a mechanical support function and may therefore be of a very simple construction. In particular, this frame need not have electrical components or any cooling devices whatsoever.

Before being introduced into the receiving space of the cooling station, the frame with the product to be cooled accommodated thereon may be stored for example in a refrigerator room or a cold store.

It is thereby guaranteed that the cooling chain is not interrupted either during storage or during the further processing, in particular portioning, of the product to be cooled.

In a preferred development of the cooling station according to the invention it is provided that the cooling station is mobile in order to allow the cooling station to be used flexibly and positioned for example at various points of a food conveyor belt.

The mobility of the cooling station may be achieved for example by providing the cooling station with castors.

The product to be cooled that is accommodated on the frame is protected from an addition of heat from the environment particularly effectively if the housing of the cooling station surrounds the receiving space for receiving the frame on at least four sides.

The housing walls surrounding the receiving space of the cooling station are preferably provided with thermal insulation.

To achieve the effect whereby the cooled circulating air flow is generated only when it is needed to produce a cold-air curtain above a frame introduced into the cooling station, it is advantageous if the cooling station has a switch, which, as the frame is introduced into the cooling station, automatically activates the generation of a cooled circulating air flow through the frame.

Such a switch may in particular take the form of a magnetically operated switch.

In particular it may be provided that the switch comprises a reed contact, which, as the frame is introduced into the receiving space of the cooling station, owing to the presence of a magnet disposed on the frame closes an electrical contact and hence activates the circulating-air cooling device, in particular the fan and the cooler.

The cooler may in principle be of any desired construction, and the cooling effect of the cooler may be achieved in any desired manner. For example, the cooler might take the form of the evaporator of a refrigerating unit.

In a preferred development of the invention it is however provided that the cooler takes the form of a heat exchanger, which at the cold side contains a multiphase, flowable coolant.

The multiphase coolant, which may in particular contain a solid ice phase that is suspended in a liquid phase, is flowable, in particular pumpable, and may therefore be fed from an external coolant source to the cooling station, so that there is no need for any refrigerating unit whatsoever inside the cooling station.

A multiphase coolant may absorb heat from the circulating air flow and convert it to latent heat in that some of the solid phase of the coolant is melted without this leading to a variation of the temperature of the coolant, at any rate so long as the solid phase of the coolant is not completely melted.

Such a latent coolant has a comparatively high specific energy density.

The use of a multiphase coolant with a defined melting temperature at the cold side of the cooler of the cooling station makes it possible to dispense with temperature control of the circulating air flow.

In principle, the cold side of the heat exchanger might be designed as a coolant storage tank, in which the coolant, once introduced, remains until its heat absorption capacity is exhausted.

In a preferred development of the invention it is however provided that a device allowing the coolant to circulate through the cooler is associated with the cooling station. The effect thereby achieved is that the cold side of the heat exchanger always has a particularly high heat absorption capacity.

It is further preferably provided that the cooling station can be connected by at least one coolant line to an external coolant source and/or an external coolant sink.

As a result, the multiphase flowable coolant may be drawn from the external coolant source and need not be produced or regenerated in the cooling station itself. What is more, spent coolant may be discharged to the external coolant sink.

If in an advantageous manner at least one coolant line is of a flexible design, the cooling station may be disposed in different positions relative to the external coolant source and/or relative to the external coolant sink, thereby increasing the flexibility of use of the cooling station.

It is further preferably provided that the multiphase, flowable coolant is a binary ice.

Binary ice (also known as flow ice or smart ice) is a flowable and pumpable two-phase mixture of a solid ice phase and a liquid water/alcohol phase (which therefore contains water and an alcohol as a substance lowering the freezing point), in which the ice phase is suspended.

The melting temperature of the ice phase depends upon the type of alcohol used (for example ethanol) and upon the alcohol fraction selected.

If this binary ice is used to cool the circulating air flow, then the binary ice absorbs heat from the circulating air flow and converts it to latent heat of the binary ice in that some of the ice phase of the binary ice is melted without this leading to a variation of the temperature of the binary ice, at any rate so long as the ice phase of the binary ice is not completely melted.

Binary ice by virtue of these properties and by virtue of its pumpability is ideally suitable for use as a latent coolant in the cooling station according to the invention.

By virtue of its ice fraction the binary ice moreover has a comparatively high specific energy density.

In order to generate the circulating air flow through the frame accommodated in the receiving space of the cooling station, it may be provided that the cooling station has at least one outlet opening for blowing out cooled circulating air into the frame.

It may further be provided that the cooling station has at least one intake opening for taking in circulating air from the frame.

Claim 15 is directed to a combination of a cooling station according to the invention and at least one frame, which has receivers for a product to be cooled and can be introduced in such a way into the receiving space of the cooling station that the cooling station surrounds the frame on at least three sides.

Such a frame is preferably mobile so that it may be moved for example from the refrigerator room to the cooling station.

This mobility may be achieved in particular by providing the frame with castors.

To enable an ergonomic operation when an operator removes cooled product from the receivers of the frame introduced into the receiving space of the cooling station, it is advantageous if the frame introduced into the receiving space of the cooling station is accessible on at least one side for the removal of cooled product from the receivers for the product to be cooled.

For free accessibility to the cooled product accommodated on the frame it is particularly advantageous if the frame introduced into the receiving space of the cooling station is accessible on at least two sides, for example from the front and from the top, for the removal of cooled product from the receivers for the product to be cooled.

Cooling of the product to be cooled may be effected particularly efficiently if the receiving space of the cooling station is adapted in such a way to the shape of the frame that the frame is completely accommodated by the receiving space.

The frame may be filled with product to be cooled in a particularly simple manner if the receivers of the frame are designed to receive Gastronorm containers.

The product to be cooled that is accommodated on the receivers of the frame preferably comprises food and/or drinks.

In a preferred development of the invention it is provided that the frame takes the form of a rack trolley, on which food containers, drinks containers or trays may be suspended.

The cooling station according to the invention and the combination according to the invention of a cooling station according to the invention and a frame, which has receivers for a product to be cooled and is introducible in such a way into the receiving space of the cooling station that the cooling station surrounds the frame on at least three sides, are particularly suitable for use as components of a portioning system for a large-scale catering establishment.

Besides the cooling station and the container dockable with the cooling station, such a portioning system may in addition comprise further components, in particular a food conveyor belt, at least one mobile dispenser, and at least one central cooling station adapted to the mobile dispenser and having a docking place for docking the mobile dispenser for a circulating-air cooling of a receiving space of the dispenser.

The concept according to the invention offers the advantage that the frame filled with the product to be cooled may be moved from any desired location to the cooling station without any cooling device whatsoever having to be moved along with the frame.

The frame may therefore be of a small, light and manoeuvrable design combined with a relatively high loading capacity.

Because there is no need for a refrigerating unit on the frame, the frame does not generate waste heat. The area surrounding the frame is therefore not burdened with waste heat that has to be dissipated.

During portioning the frame is still kept cool in the receiving space of the cooling station without the area surrounding the cooling station having to be cooled and without the operating personnel being exposed to the cold.

Prior to portioning the frame may be parked in a refrigerator room or a cold store, where it is cooled together with the product to be cooled that is disposed thereon.

In this case, the product to be cooled may be accommodated in a space-saving manner in Gastronorm containers on the frame.

For portioning, the frame together with the Gastronorm containers disposed thereon is moved into the cooling station situated beside a cooled food conveyor belt. From here, portioning of the food is effected from the frame, an increase in the temperature of the cooled product being prevented by the cooling station.

The cold from the cooler of the cooling station is supplied by the circulating-air cooling system precisely to the product to be cooled in the receiving space of the cooling station, with the result that large areas of a portioning centre, in which such a cooling station is disposed, may remain uncooled. This saves energy and prevents the operating personnel of the portioning centre from being exposed to the cold.

Given the use of binary ice to cool the circulating air flow, a correct layout of the cooler, an adequate ratio of cooler capacity to cooling demand and a binary ice temperature of ca. −3° C., the temperature arising in the receiving space of the cooling station is always in the region of between 0° C. and 10° C.

Because of the high energy density of the binary ice compared to conventional liquid refrigerants, when binary ice is used only a considerably lower volumetric flow need be circulated through the cooler, this having a positive effect on the energy balance of the system.

By means of the cooling station according to the invention the temperature of the product to be cooled in the receiving space of the cooling station may be both maintained as well as lowered.

It is particularly advantageous if the circulating-air cooling of the frame is not started until it is required, namely when the frame has been introduced into the cooling station.

The circulating air flows directly against the product to be cooled in the receiving space of the cooling station, with the result that the product to be cooled is cooled in a very efficient manner and so short cooling cycles may be realized.

The frame may be of a small and manoeuvrable design because it itself does not contain any cooling equipment.

When there is no cooling demand because no frame has been introduced into the receiving space of the cooling station, the circulating-air cooling of the cooling station is turned off by means of a switch.

The use of binary ice as a multiphase, flowable refrigerant offers the advantage that this refrigerant absorbs heat from the circulating air as latent heat and so in the cooler of the cooling station at the cold side there is always an optimum temperature for cooling food of ca. −3° C. without any temperature control being required for this purpose, thereby allowing a very simple construction of the cooling station according to the invention.

It is only if a frame introduced into the cooling station is to be permanently cooled that a cyclical defrosting operation has to be activated.

The quantity of heat that may be absorbed by binary ice without impairing the cooling action of the binary ice is markedly higher than in the case of refrigerants without a phase change. The volumetric flow of the refrigerant through the cooler of the cooling station that is needed to cool the circulating air is therefore markedly lower when binary ice is used.

Nevertheless, instead of binary ice it is possible to use a different flowable refrigerant, for example a water-brine mixture without a phase change or a conventional one-phase refrigerant, to cool the circulating air. The cooling station according to the invention is particularly suitable for use in the portioning of food in institutional catering, in particular in centralized kitchens, large hospitals etc.

Further features and advantages of the invention are the subject matter of the following description and the graphical representation of embodiments.

### BRIEF DESCRIPTION OF THE DRAWINGS

FIG. 1 a diagrammatic top view of a portioning system for a large-scale catering establishment having a central cooling station and a food conveyor belt, along which a tray-stacking trolley, a serving trolley, a plurality of tableware- and food dispensers, a low mobile cooling station with an inserted low rack trolley, a high mobile cooling station with an inserted high rack trolley and a tray-conveying trolley are disposed;

FIG. 2 a diagrammatic representation of a binary ice supply system for the central cooling station, for a high mobile cooling station and for a low mobile cooling station;

FIG. 3 a diagrammatic top view of a central cooling station having six docking places for movable dispensers;

FIG. 4 a diagrammatic vertical section through a docking place of a central cooling station;

FIG. 5 a diagrammatic vertical longitudinal section through a mobile dispenser with a cover placed thereon;

FIG. 6 a diagrammatic vertical section through a docking place of a central cooling station with a mobile dispenser docked therewith;

FIG. 7 an enlarged representation of the region I of FIG. 6;

FIG. 8 a diagrammatic longitudinal section through a second form of construction of a mobile dispenser, the docking points of which are provided with closure flaps, the closure flaps being situated in a closed position;

FIG. 9 an enlarged representation of the region II of FIG. 8, wherein the represented closure flap is situated in an open position;

FIG. 10 a diagrammatic section through a third form of construction of a mobile dispenser, onto which a cover made of Plexiglas has been placed;

FIG. 11 a diagrammatic vertical section through a docking place of a central cooling station and a mobile dispenser, which is docked therewith and onto which no cover has been placed, wherein a cover is mounted pivotably on the central cooling station and situated in an open position, in which a top access opening of the mobile dispenser is open;

FIG. 12 a diagrammatic vertical section corresponding to FIG. 11 through a docking place of a central cooling station and a mobile dispenser docked therewith, wherein the cover mounted pivotably on the central cooling station has been pivoted into a closed position, in which the cover closes a top access opening of the mobile dispenser;

FIG. 13 a diagrammatic perspective representation of a high mobile cooling station, into which a high rack trolley is insertable;

FIG. 14 a diagrammatic front view of the high mobile cooling station of FIG. 13, wherein part of the back wall of the cooling station has been removed to reveal the cooling coils of a cooler of the cooling station;

FIG. 15 a diagrammatic perspective representation of a high rack trolley;

FIG. 16 a diagrammatic perspective representation of a combination of a high mobile cooling station and a high rack trolley inserted into the cooling station;

FIG. 17 a diagrammatic front view of the combination of the high mobile cooling station and the high rack trolley inserted into the cooling station;

FIG. 18 a diagrammatic, part-sectional bottom plan view of the combination of the high mobile cooling station and the high rack trolley inserted into the cooling station, in which a circulating air flow passing through the cooling station and the rack trolley is diagrammatically represented by arrows;

FIG. 19 a diagrammatic perspective representation of a low mobile cooling station;

FIG. 20 a diagrammatic perspective representation of a low rack trolley; and

FIG. 21 a diagrammatic perspective representation of the low mobile cooling station of FIG. 19, in which the circulating air flow passing through the low rack trolley in the inserted state thereof is additionally represented by arrows.

In all of the figures identical or functionally equivalent elements are denoted by the same reference characters.

### DETAILED DESCRIPTION OF THE INVENTION

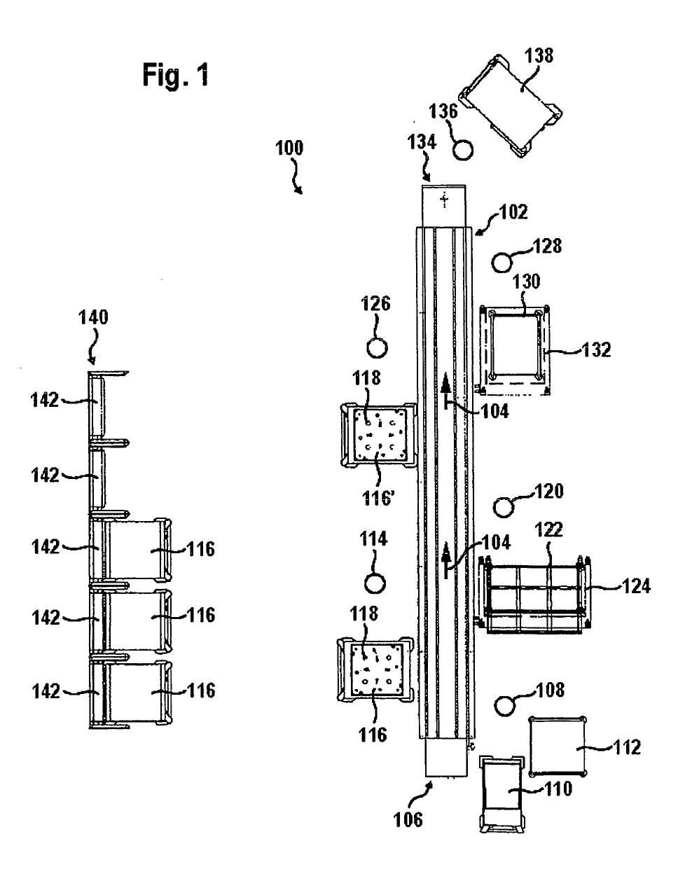

A portioning system 100 for portioning food and/or drinks in a large-scale catering establishment is represented as a whole in FIG. 1 and comprises a food conveyor belt 102, which is cooled by circulating air and the running direction of which is indicated by arrows 104.

In an initial region 106 (at the bottom in the representation of FIG. 1) trays that are removed from a tray-stacking trolley 110 by an operator standing at the point 108 are placed onto the food conveyor belt 102 and loaded with uncooled food, drinks or tableware from a serving trolley 112.

From a mobile dispenser 116, which is positioned next to the food conveyor belt 102 and the top access opening 118 of which is freely accessible, cooled food, drinks and/or tableware are placed by an operator standing at the point 114 onto the trays conveyed by the food conveyor belt 102 in the running direction 104.

Portions of food from Gastronorm containers suspended from a low rack trolley 122 are placed by an operator standing at the point 120 onto the trays conveyed further in the running direction 104 of the food conveyor belt 102.

The low rack trolley 122 is inserted into a low mobile cooling station 124 that generates a cooled circulating air flow through the low rack trolley 122.

From a second mobile dispenser 116′, the top access opening 118 of which is freely accessible, further food, drinks and/or tableware items are placed by an operator standing at the point 126 onto the trays conveyed further in the running direction 104 of the food conveyor belt 102.

From Gastronorm containers that are suspended from a high rack trolley 130 portions of cooled food are placed by an operator standing at the point 128 onto the trays conveyed further in the running direction of the food conveyor belt 102.

The high rack trolley 130 is inserted into a high mobile cooling station 132 that generates a cool circulating air flow through the high rack trolley 130.

In an end region 134 of the food conveyor belt 102 the fully loaded trays are removed from the food conveyor belt 102 and introduced into the receiving chamber of a tray-conveying trolley 138, which is pre-cooled by means of binary ice, by an operator situated at the point 136.

Disposed at a distance from the food conveyor belt 102 is a central cooling station 140 that comprises a plurality of—for example five—docking places 142 for the docking of mobile dispensers 116, wherein the central cooling station 140 generates a cool circulating air flow through each of the docked mobile dispensers 116.

The cold needed for cooling items or keeping items cool is supplied to all of the cooling elements of the portioning system 100 by means of a multiphase, flowable coolant, in particular in the form of a binary ice.

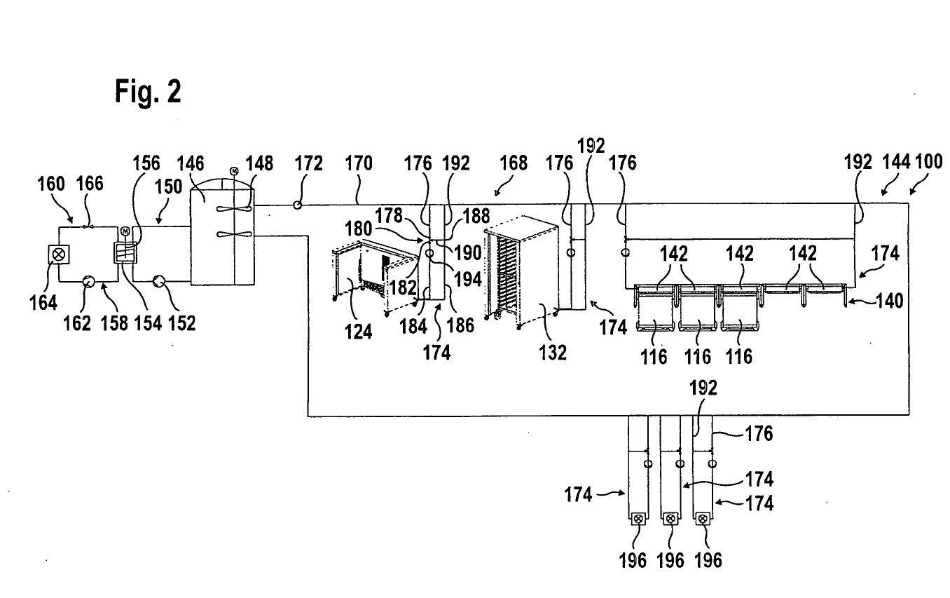

The binary ice supply system 144 of the portioning system 100 is diagrammatically represented in FIG. 2 and comprises a process tank 146, which is used as the main reservoir for the binary ice and in which the binary ice is continuously circulated by means of motor-driven rotors 148 in order to obtain as homogeneous a binary ice mixture as possible in the process tank 146.

In a primary circuit 150 binary ice from the process tank 146 is fed by means of a primary pump 152 to an ice generator 154 having a motor-driven mixer 156, which simultaneously scrapes off ice that has frozen on the inner wall of the ice generator 154, and from there back into the process tank 146.

The ice generator 154 is cooled by means of a conventional refrigeration device 158, which comprises a refrigerant circuit 160 having a refrigerant compressor 162, a condenser 164 and a flash restrictor 166.

The binary ice, which is generated in the ice generator 154 by means of the cold supplied by the refrigeration device 158 and is stored in the process tank 146, is circulated in a secondary circuit 168 and discharged from there to local consumer circuits 174 of the low mobile cooling station 124, the high mobile cooling station 132 and the central cooling station 140. Melted binary ice from these local consumer circuits 174 is received by the secondary circuit 168 and fed into the process tank 146.

The secondary circuit 168 comprises a circulation line 170 that leads from the process tank 146, past the standing positions of the low mobile cooling station 124 and the high mobile cooling station 132 along the food conveyor belt 102 and, from there, to the central cooling station 140 and back into the process tank 146. Disposed in the circulation line 170 is a secondary pump 172 that circulates the binary ice from the process tank 146 through the circulation line 170.

Each of the consumer circuits 174 is connected to the circulation line 170 by a branch line 176, which branches off from the circulation line 170 and is connected to a first input 178 of a three-way valve 180.

In each case, a binary-ice inlet line 184 leads from an output 182 of the three-way valve 180 to a binary-ice inlet connection of the respective cold consumer, for example the low mobile cooling station 124.

Inside the respective consumer a line system is provided, which carries the binary ice from the binary-ice inlet connection through a cold consumer, in particular a cooler, and back to a binary-ice return connection of the respective consumer.

The binary-ice return connection is connected to a binary-ice return line 186 that leads to a junction 188.

From the junction 188 a binary-ice return line 190 leads to a second input of the three-way valve 180, thereby producing a closed consumer circuit 174.

A binary-ice discharge line 192 further leads from the junction 188 back to the circulation line 170 of the secondary circuit 168.

In order to supply fresh binary ice from the secondary circuit 168 to the respective consumer circuit 174, the respective three-way valve 180 is switched into a state, in which the first input of the three-way valve 180 is connected to the output thereof, so that fresh binary ice passes through the branch line 176 into the binary-ice inlet line 184.

Disposed in the binary-ice inlet line 184 is a pump 194 that feeds the binary ice from the binary-ice inlet line 184 into the respective consumer, for example into the low mobile cooling station 124.

As in this filling state of the consumer circuit 174 the second input of the three-way valve 180, to which the binary-ice return line 190 is connected, is closed, simultaneously with the supply of fresh binary ice through the branch line 176 spent melted binary ice is fed through the binary-ice discharge line 192 into the circulation line 170 of the secondary circuit 168 and, from there, back into the process tank 146.

Once the desired quantity of fresh binary ice has been fed to the consumer circuit 174, the three-way valve 180 is switched into a state, in which its second input is connected to the output and the first input 178 of the three-way valve 180 is closed.

In this state, the binary ice is circulated by means of the pump 194 in the closed consumer circuit 174 through the respective consumer, for example the low mobile cooling station 124.

The switching of the three-way valve 180 between its two states may be triggered for example because of the signal of a temperature sensor that measures a temperature inside the cold consumer or the temperature of the binary ice at one point of the consumer circuit 174.

Since the junction 188 of the consumer circuit 174 is situated lower than the circulation line 170 of the secondary circuit 168, as a result of the effect of gravity substantially no binary ice passes from the consumer circuit 174 into the circulation line 170 of the secondary circuit 168 so long as the consumer circuit 174 is closed by the three-way valve 180 and binary ice may pass from the junction 188 through the binary-ice return line 190 back into the binary-ice inlet line 184.

The consumer circuits 174 of the low mobile cooling station 124, the high mobile cooling station 132 and the central cooling station 140 are all of a substantially identical construction and operate in the previously described manner.

The binary-ice inlet lines 184 leading to the mobile cooling stations 124 and 132 and the binary-ice return lines 186 are preferably of a flexible design to allow the mobile cooling stations 124 and 132 to be disposed in different positions relative to the circulation line 170 of the secondary circuit 168.

Besides the previously described cold consumers, further consumers 196, for example the food conveyor belt 102, another cooled portioning- or conveyor belt, one or more cold stores, one or more refrigerators etc., may additionally also be supplied by means of a consumer circuit 174 with circulating binary ice and connected by a respective branch line 176 and a binary-ice discharge line 192 to the circulation line 170 of the secondary circuit 168.

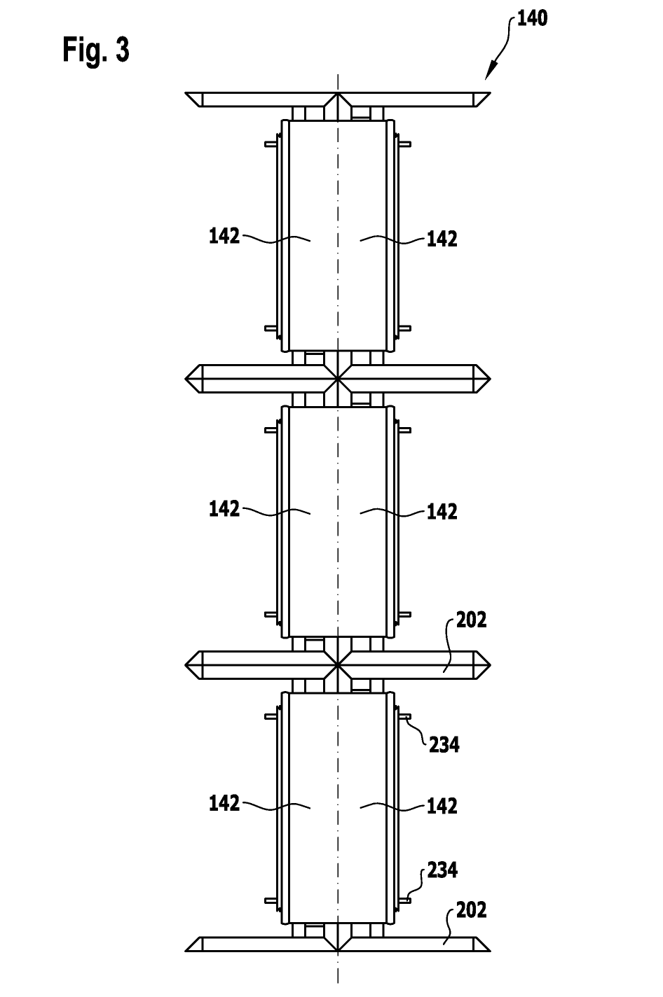

There now follows a detailed description of the construction of the central cooling station 140 with reference to FIGS. 3 to 7.

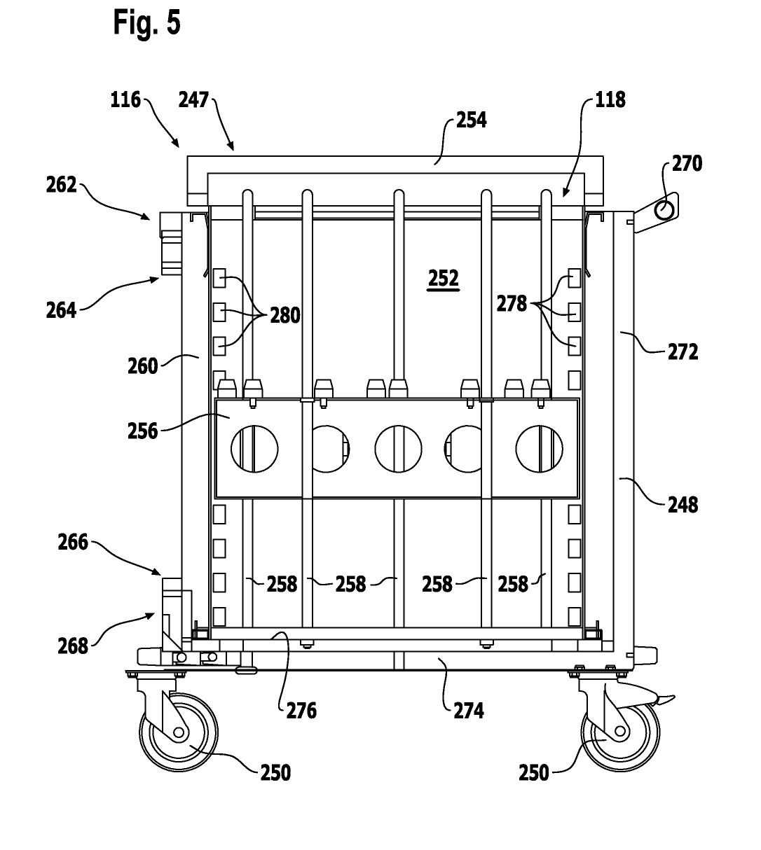

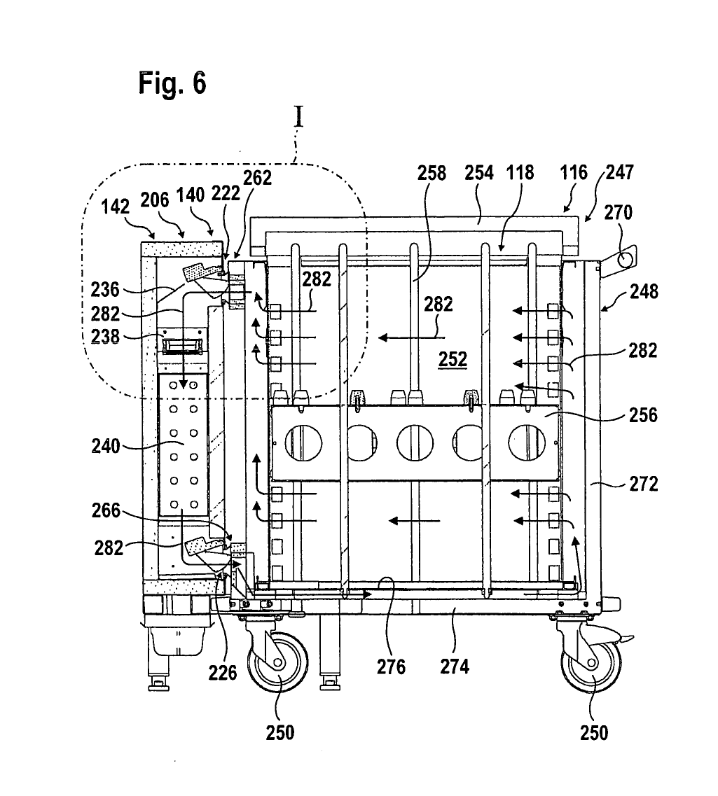

The central cooling station 140 comprises a plurality of docking places 142 for the docking of in each case one mobile dispenser 116 of the type represented in FIGS. 5 and 6.

In this case, as is represented for example in FIGS. 1 and 2, a plurality of—for example five—docking places 142 may be arranged linearly alongside one another.

In FIGS. 1 and 2 in each case three of the docking places 142 are occupied by docked dispensers 116, while two further docking places 142 are vacant.

It is also possible to position two docking places 142 in each case back to back so that they may each be approached by a dispenser 116 from mutually opposite directions, as is represented in FIG. 3 by way of example for a total of six docking places 142, each two of which are positioned in a pair back to back in each case.

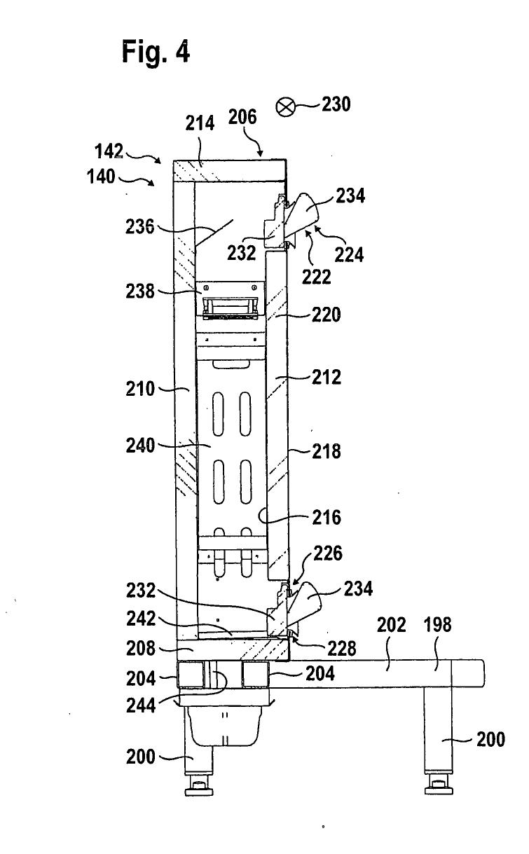

As may best be seen from FIG. 4, each docking place 142 of the central cooling station 140 comprises a supporting frame 198 having supports 200, by which the central cooling station 140 is supported on a floor, and having cross-members 202 extending substantially horizontally and transversely of a longitudinal direction 230 of the central cooling station 140 and serving as guide devices for a dispenser 116 that is to be moved up to the docking place 142.

Two longitudinal members 204 extending substantially horizontally and at right angles to the cross-members 202 carry a substantially cuboidal housing 206, which comprises a bottom wall 208, a vertical back wall 210, a vertical front wall 212, non-illustrated vertical side walls and a vertical top wall 214.

Each wall of the housing 206 is provided with an inner lining 216 and an outer lining 218 made of sheet metal as well as with thermal insulation 220 disposed between the inner lining 216 and the outer lining 218.

The front wall 212 facing the respective docked dispenser 116 has a first docking point 222 in the form of an air inlet 224 and, beneath this, a second docking point 226 in the form of an air outlet 228.

Each of the two docking points 222, 226 comprises a substantially rectangular air through-opening, which extends in the longitudinal direction 230 of the central cooling station 140 and is closable by means of a closure flap 232 when there is no dispenser 116 at all docked with the relevant docking place 142.

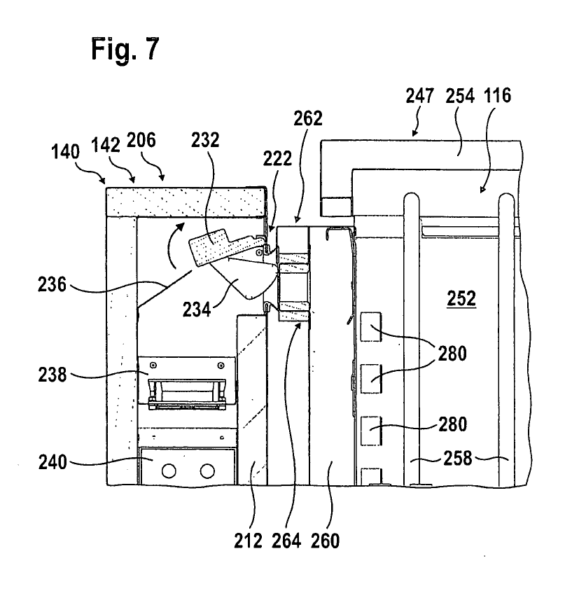

Each of the closure flaps 232 is mounted on the housing 206 rotatably about an axis of rotation, which extends horizontally and parallel to the longitudinal direction 230 of the central cooling station 140, in such a way that the closure flap 232 is rotatable from the closed position represented in FIG. 4, in which the closure flap 232 closes the through-opening of the respective docking point 222 and/or 226, inwards into the open position represented in FIG. 7, in which the closure flap 232 frees the through-opening of the respective docking point 222 and/or 226.

So that the closure flap 232 during docking of the dispenser 116 is rotated automatically from the closed position into the open position, each closure flap 232 is provided with in each case two actuating projections 234, which are mutually spaced apart in the longitudinal direction of the closure flap 232 and which in the closed state of the closure flap 232 project slightly out beyond the opening cross section of the air through-opening and are displaced by the dispenser 116 into the interior of the housing 206 when the dispenser 116 is moved against the front wall 212 of the docking place 142 (see FIGS. 6 and 7).

By virtue of this displacement of the actuating projections 234 the respective closure flap 232 is rotated about its axis of rotation from the closed position into the open position.

When the mobile dispenser 116 is removed from the docking place 142, each closure flap 232 rotates under the effect of gravity from the open position back into the closed position, in which the closure flap 232 closes the through-opening of the respective associated docking point 222 and/or 226.

As may best be seen from FIG. 4, in the interior of the housing 206 of each docking place 142 an air baffle 236, a fan 238 and a cooler 240 are disposed between the upper first docking point 222 and the lower second docking point 226.

The cooler 240 takes the form of a heat exchanger and contains heat exchanger coils, which at the cold side are filled with binary ice that is circulated through the central cooling station 140 in the consumer circuit 174 associated with the central cooling station 140.

In this case, the coolers 240 of the various docking places 142 may be connected in series or in parallel to one another.

In order that water condensate formed at the cooler 240 may be removed from the housing 206 of the docking place 142 and collected, there is disposed at the bottom of the housing 206 a collecting trough 242, the base of which is inclined towards a mouth orifice of a collecting pipe 244, wherein the collecting pipe 244 extends through the bottom wall 208 of the housing 206 into a condensate collecting tank, which is suspended from the supporting frame 198 and may for example take the form of a Gastronorm food container.

The dispenser 116 dockable with the docking place 142 of the central cooling station 140 is individually represented in FIG. 5 and takes the form of a mobile container 247 comprising a substantially cuboidal, thermally insulated housing 248 that is provided at its underside with castors 250, by means of which the dispenser 116 is movable over a floor.

The receiving space 252 surrounded by the housing 248 and provided for receiving a product to be cooled is accessible via an access opening 118 at the top of the dispenser 116 in order to introduce product to be cooled into the receiving space or remove cooled product from the receiving space 252.

This top access opening 118 is closable by means of a thermally insulated cover 254 that may be placed onto the housing 248.

Disposed in the receiving space 252 is a platform 256 that carries the product to be cooled and is guided in a vertically displaceable manner on a plurality of vertical guide rods 258.

A front wall 260 of the housing 248 of the dispenser 116 that faces the docking place 142 of the central cooling station 140 in the docked state of the dispenser 116 is provided with a first docking point 262 in the form of an air outlet 264 and, beneath this, with a second docking point 266 in the form of an air inlet 268.

Each of the docking points 262, 266 of the dispenser 116 comprises an air through-channel, by which the receiving space 252 is connected to the exterior of the housing 248 of the dispenser 116.

In the form of construction represented in FIG. 5 these air through-channels are permanently open.

The dispenser 116 is loaded with tableware, cold food or cold drinks and then docked with a vacant docking place 142 of the central cooling station 140 by being moved, front wall 260 of its housing 248 first, against the front wall 212 of the housing 206 of the docking place 142.

To push and steer the mobile dispenser 116 a push handle 270 is used, which is disposed on a back wall 272 of the housing 248 of the dispenser 116 remote from the front wall 260.

When the dispenser 116 is moved into the docking place 142, the first docking point 262 of the dispenser 116 comes into contact with the first docking point 222 of the docking place 142 and the second docking point 266 of the dispenser comes into contact with the second docking point 226 of the docking place 142, thereby producing air ducts, which are sealed off from the environment and by which the interior of the housing 206 of the docking place 242 is connected to the receiving space 252 of the mobile dispenser 116.

During docking the actuating projections 234 on the closure flaps 232 of the docking points 222 and 226 of the docking place 142 are displaced by the docking points 262 and 266 respectively of the dispenser 116, so that the closure flaps 232 are moved from their closed position into their open position and the air ducts between the dispenser 116 and the docking place 142 are open.

Once the dispenser 116 is docked with the docking place 142, a circulating air flow is generated by means of the fan 238 and passes from the fan 238 through the cooler 240 and through the second docking points 226 and 266 into a region between a bottom wall 274 of the housing 248 of the dispenser 116 and a bottom sheet 276 disposed above it and, from there, into the back wall 272 of the dispenser 116.

Through air through-openings 278, which are distributed over the entire height of the back wall 272, the circulating air passes over the entire height of the receiving space 252 into the receiving space 252 in order to cool the product to be cooled that is situated there.

Through air through-openings 280, which are distributed over the entire height of the front wall 260 of the housing 248 of the dispenser, the circulating air passes out of the receiving space 252 into the front wall 260 of the dispenser 116 and, from there, through the first docking point 262 of the dispenser 116 and the first docking point 222 of the docking place 142 back to the fan 238, with the result that the circuit is closed.

The circulating air flow is represented diagrammatically by the arrows 282 in FIG. 6.

The cooling of the circulating air in this case is effected by heat transfer in the cooler 240 in the form of a heat exchanger to the binary ice flowing through the cooler 240 at the cold side.

By virtue of the use of binary ice as a coolant no temperature regulation of the circulating air cooling system is necessary. The binary ice circulates permanently through the cooler 240 of the docking place 142.

The dispenser 116 remains docked with the docking place 142 of the central cooling station 140 and continues to be cooled by circulating air until it is pushed up to the food conveyor belt 102 for removal of the cooled product it contains.

By virtue of the fact that the access opening 118 of the dispenser 116 in the docked state is covered by the thermally insulated cover 254, an energy-saving cooling operation is guaranteed.

At the food conveyor belt 102 as a rule no further cooling of the dispenser 116 is necessary because the cooled product, in particular the cooled tableware, as a result of its high specific heat capacity has stored enough cold to remain sufficiently cold, i.e. at a temperature of less than 8° C., during the relatively short period of the portioning at the food conveyor belt 102.

For the portioning at the food conveyor belt 102 the cover 254 is removed in order to gain access through the access opening 118 to the cooled product in the receiving space 252.

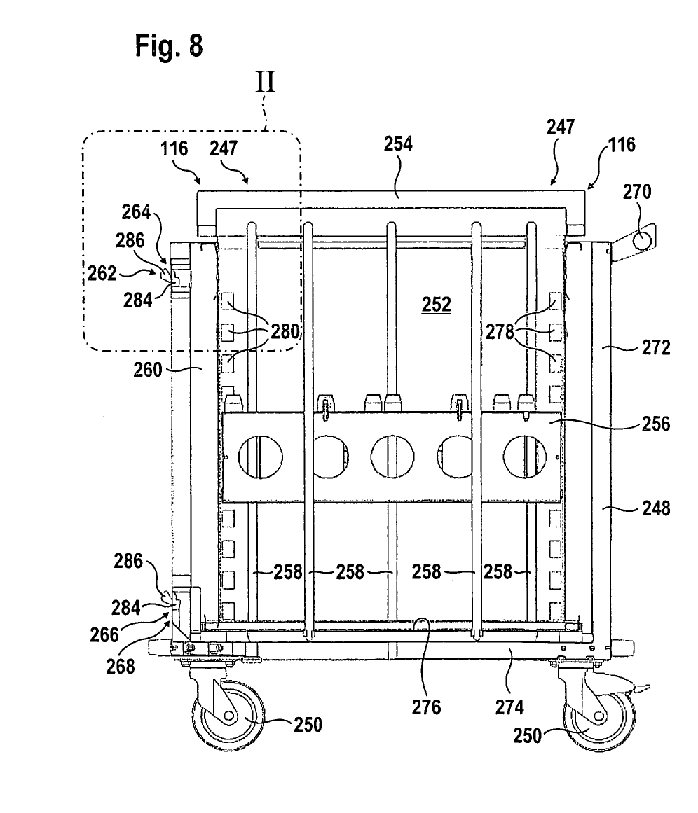

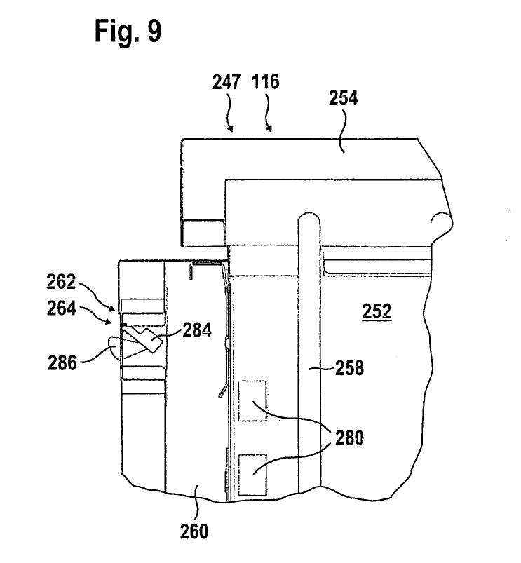

A second form of construction of a mobile dispenser 116 that is represented in FIGS. 8 and 9 differs from the previously described form of construction represented in FIGS. 5 and 6 in that the air through-channels of the first docking point 262 and the second docking point 266 are not permanently open but are closed in the undocked state in each case by means of a closure flap 284.

Each of the closure flaps is mounted on the housing 248 rotatably about an axis of rotation, which extends horizontally and parallel to the front wall 260 of the housing 248 of the dispenser 116, in such a way that the closure flap 284 is rotatable out of the closed position represented in FIG. 8, in which the closure flap 284 closes the air through-channel of the respective associated docking point 262 and/or 266, into the open position represented in FIG. 9, in which the closure flap 284 frees the relevant air through-channel.

To achieve the effect whereby the closure flaps 284 during docking of the dispenser 116 with the central cooling station 140 each rotate automatically out of the closed position into the open position, each of the closure flaps 284 is provided with one or more actuating projections 286, which at least in the closed state project slightly out beyond the opening cross-section of the respective associated air through-channel and during docking of the dispenser 116 with the central cooling station 140 are displaced by the respective associated docking point 222 and/or 226 of the docking place 142 of the central cooling station 140 into the interior of the dispenser 116, with the result that the respective closure flap 284 is automatically rotated out of the closed position into the open position.

During undocking of the dispenser 116 from the docking place 142, the closure flaps 284 rotate under the effect of gravity out of the open position back into the closed position, so that the air through-channels of the docking points 262, 266 of the dispenser 116 are closed when the dispenser 116 is undocked from the central cooling station 140.

Otherwise the second form of construction of a dispenser 116 represented in FIGS. 8 and 9 is identical in construction and function to the first form of construction represented in FIGS. 5 and 6, to the previous description of which reference is made in this respect.

This second form of construction of a dispenser 116 with closure flaps 284 may be used together with a central cooling station 140 that likewise has closure flaps 232 at its docking points 222, 262 or with an alternative central cooling station 140 having air inlets 224 and air outlets 228 that are permanently open.

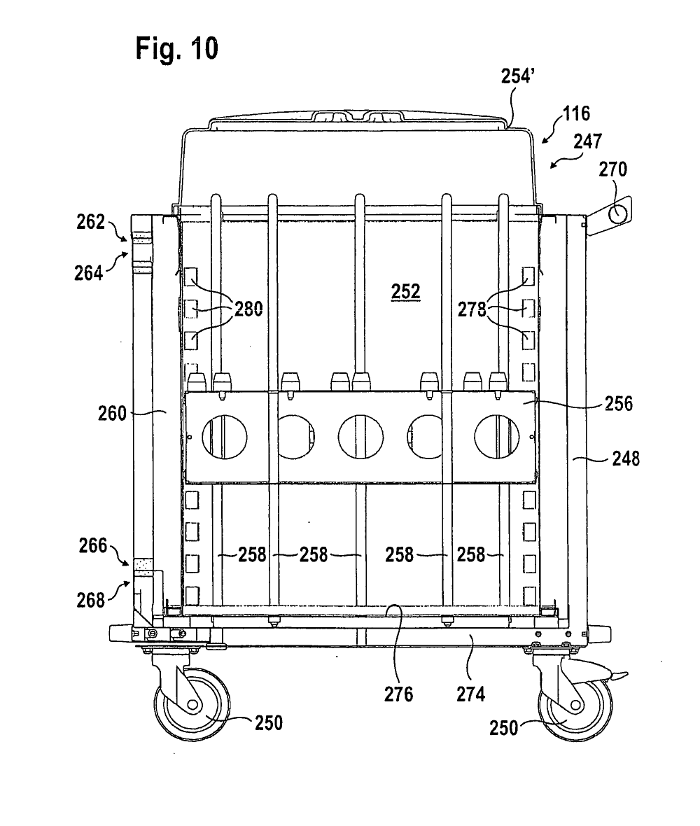

A third form of construction of a mobile dispenser 116 that is represented in FIG. 10 differs from the two previously described forms of construction in that, instead of a non-transparent cover 254 made of a sheet-metal lining and thermal insulation disposed in the interior of the lining, a cover 254′ made of a transparent material, for example of Plexiglas, is placed onto the housing 248 of the dispenser 116 in order to close the top access opening 118 of the dispenser 116 when the latter is docked with the central cooling station 140.

The use of a transparent cover 254′ offers the advantage that by glancing through the cover 254′ it is easy to determine which product to be cooled is contained in the relevant dispenser 116, thereby making it simple to select the correct dispenser 116 that is to be moved up to the food conveyor belt 102, particularly if a plurality of mobile dispensers 116 are docked with the central cooling station 140.

Otherwise the form of construction of a mobile dispenser 116 represented in FIG. 10 is identical in construction and function to the first form of construction represented in FIGS. 5 and 6, to the previous description of which reference is made in this respect.

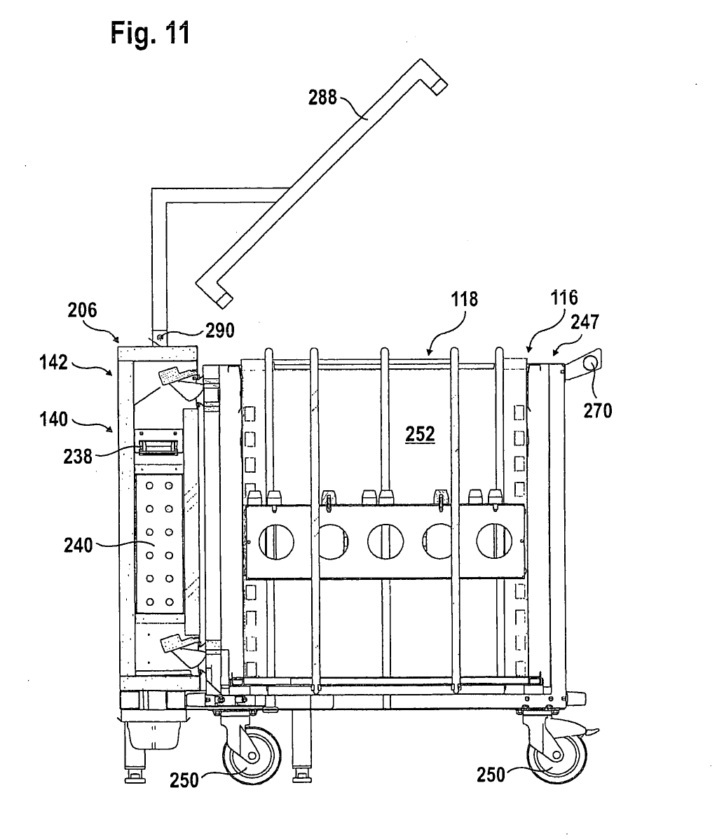

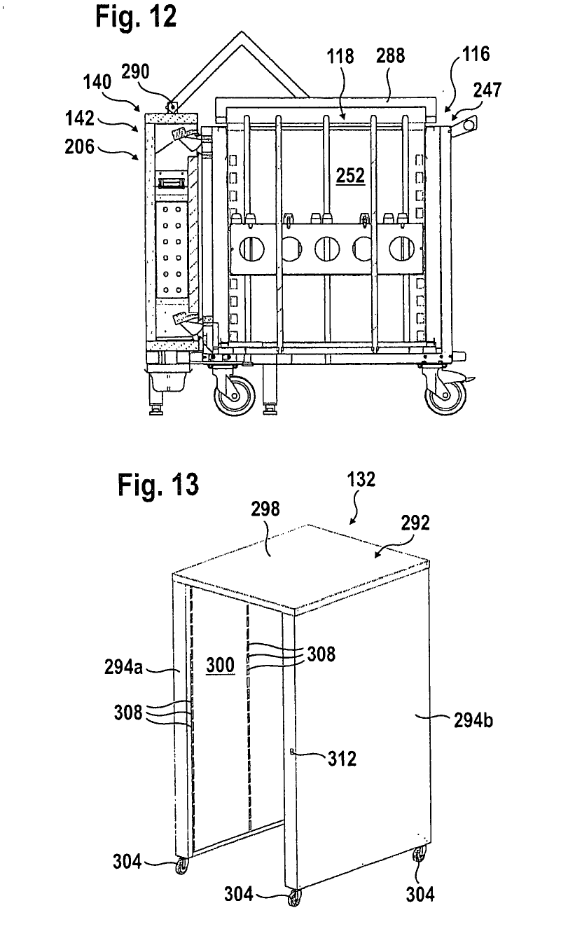

A second form of construction of a central cooling station 140 that is represented in FIGS. 11 and 12 differs from the first form of construction represented in FIGS. 3, 4, 6 and 7 in that it additionally comprises a thermally insulated cover 288 that is mounted on top of the housing 206 of a docking place 142 so as to be pivotable about a pivot axis 290 oriented horizontally and parallel to the longitudinal direction 230 of the central cooling station 140.

This cover 288 is used to close the top access opening 118 of a dispenser 116 docked with the central cooling station 140 if the relevant dispenser 116 does not have its own cover 254.

Prior to the docking of such a dispenser 116, the cover 288 is situated in the open position represented in FIG. 11, in which the cover 288 frees the access to the docking place 142 for a dispenser 116 that is to be inserted.

After docking of the dispenser 116, the cover 288 is pivoted out of its open position into the closed position represented in FIG. 12, in which the cover 288 rests on the housing 248 of the dispenser 116 and closes the top access opening 118 of the dispenser 116, thereby preventing the circulating air that is conveyed through the receiving space 252 of the dispenser 116 from escaping into the environment.

Otherwise the second form of construction of a central cooling station 140 represented in FIGS. 11 and 12 is identical in construction and function to the first form of construction represented in FIGS. 3, 4 6 and 7, to the previous description of which reference is made in this respect.

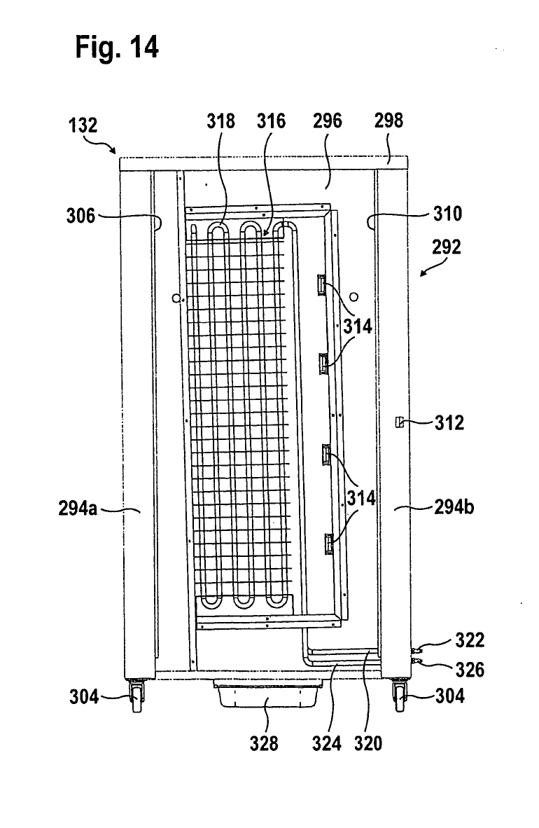

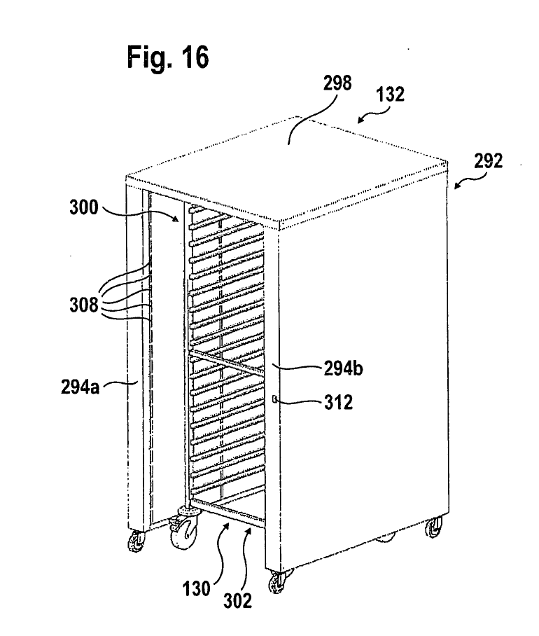

There now follows a description of the construction and function of the high mobile cooling station 132 with reference to FIGS. 13 to 18.

The high mobile cooling station 132 comprises a substantially cuboidal housing 292 having a thermally insulated vertical left side wall 294a, a thermally insulated vertical right side wall 294b, a thermally insulated vertical back wall 296 that connects the two side walls at their rear ends to one another, and a thermally insulated horizontal top wall 298 that rests on the top edges of the side walls 294a, 294b and the back wall 296.

The housing 292 therefore on four sides, namely on the left, right, rear and top, surrounds a receiving space 300 for receiving a mobile frame 302 in the form of a high rack trolley 130.

The housing 292 of the high mobile cooling station 132 has neither a bottom wall nor a front wall, with the result that the receiving space 300 is open in a downward and forward direction and the high rack trolley may be introduced from the front into the receiving space 300.

The housing 292 is provided at its underside with a plurality of—for example four—castors 304, by means of which the high mobile cooling station 132 may be moved over a floor.

The left side wall 294a of the housing 292 at its inner side facing the receiving space 300 is provided with an outlet-side air baffle 306, which comprises a plurality of—for example two—rows of outlet openings 308 extending over substantially the entire height of the side wall 294a.

In a corresponding manner, the right side wall 294b of the housing 292 at its inner side facing the receiving space 300 is provided with an intake-side air baffle 310, which comprises a plurality of—for example two—rows of intake openings extending over substantially the entire height of the right side wall 294b.

There is further disposed at the front end face of the right side wall 294b a switch 312 for switching on and off the circulating-air cooling device, yet to be described below, of the high mobile cooling station 132.

As an alternative to such a manually actuable switch 312 it may also be provided that the high mobile cooling station 132 has a magnetically operated switch comprising a reed contact, which, after a rack trolley 130 has been introduced, owing to the presence of a magnet disposed on the rack trolley 130 closes an electrical contact and hence activates the circulating-air cooling device of the high mobile cooling station 132.

The circulating-air cooling device of the high mobile cooling station 132 is disposed in the back wall 296 thereof and comprises a plurality of—for example four—circulating-air fans 314 as well as, downstream thereof, a cooler 316 in the form of a heat exchanger, which comprises a cooler pack of one or more cooling coils 318, through which binary ice may flow and which are connected by a binary-ice inlet pipe 320 to a binary-ice inlet connection 322 and by a binary-ice return pipe 324 to a binary-ice return connection 326.

The binary-ice inlet connection 322 is disposed on the outside of the right side wall 294b, takes the form of a quick-action stop valve and is connectable to the binary-ice inlet line 184 of a consumer circuit 174 of the binary-ice supply system 144 that is associated with the high mobile cooling station 132.

The binary-ice return connection 326 is likewise disposed on the outside of the right side wall 294b, takes the form of a quick-action stop valve and is connectable to the binary-ice return line 186 of the consumer circuit 174 of the binary-ice supply system 144 that is associated with the high mobile cooling station 132.

As the high mobile cooling station 132 is movable on the castors 304, the binary-ice inlet line 184 and the binary-ice return line 186 of the consumer circuit 174 associated with the high mobile cooling station 132 are preferably of a flexible design to allow the high mobile cooling station 132 to be disposed in different positions relative to the circulation line 170 of the secondary circuit 168 of the binary-ice supply system 144.

Below the cooler 316 a water condensate collecting tank 328 is suspended from the back wall 296 of the housing 292 of the high mobile cooling station 132 and receives water condensate, which has condensed at the cooler 316, and may for example take the form of a Gastronorm food container.

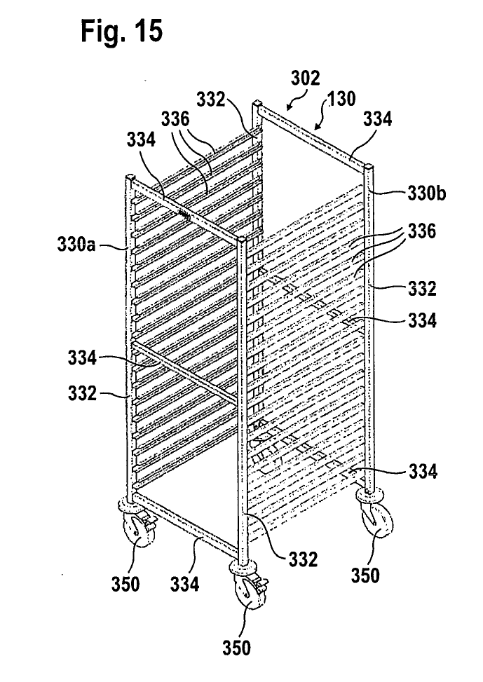

The high rack trolley 130 to be inserted into the receiving space 300 of the high mobile cooling station 132 is represented individually in FIG. 15.

The rack trolley 130 comprises a first frame 330a and a second frame 330b, each of which is composed of two vertical members 332 and three horizontal members 334 that connect the two vertical members 332 to one another, as well as a number of horizontal suspension rails 336, which connect in each case a vertical member 332 of the first frame 330a and the second frame 330b to one another and lie opposite one another in pairs and from which trays and/or food containers and/or drinks containers may be suspended.

A castor 350 is disposed on the bottom end of each of the vertical members 332 to allow the high rack trolley 130 to be moved over a floor.

The high rack trolley 130 is loaded with the product to be cooled and stored temporarily in a refrigerator room or cold store.

For portioning, the high rack trolley 130 with the product to be cooled disposed thereon is moved from the refrigerator room and/or cold store to the food conveyor belt 102 and introduced into the receiving space 300 of the high mobile cooling station 132.

After activation of the circulating air cooling of the high mobile cooling station 132 by means of the switch 312, the circulating-air fans 314 generate a circulating air flow that is cooled by means of the cooler 316.

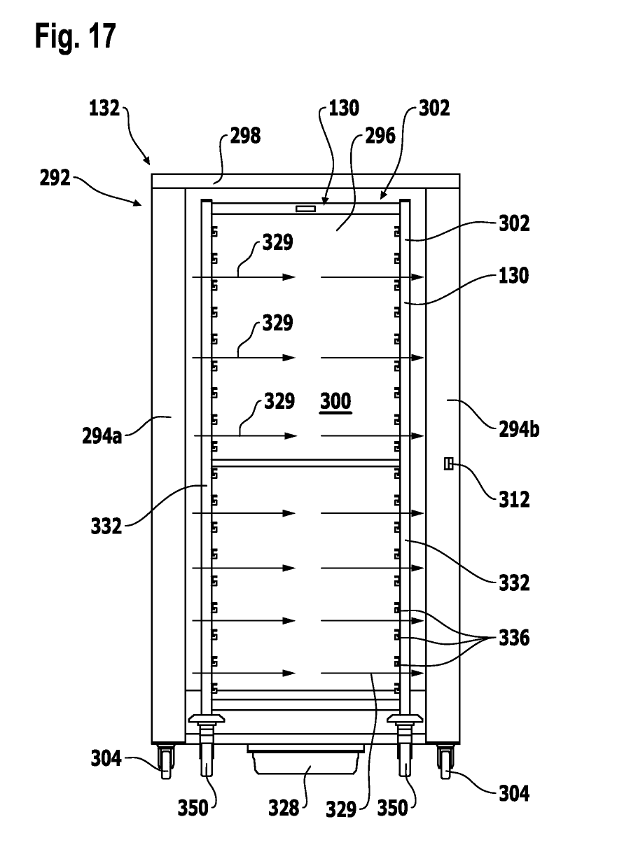

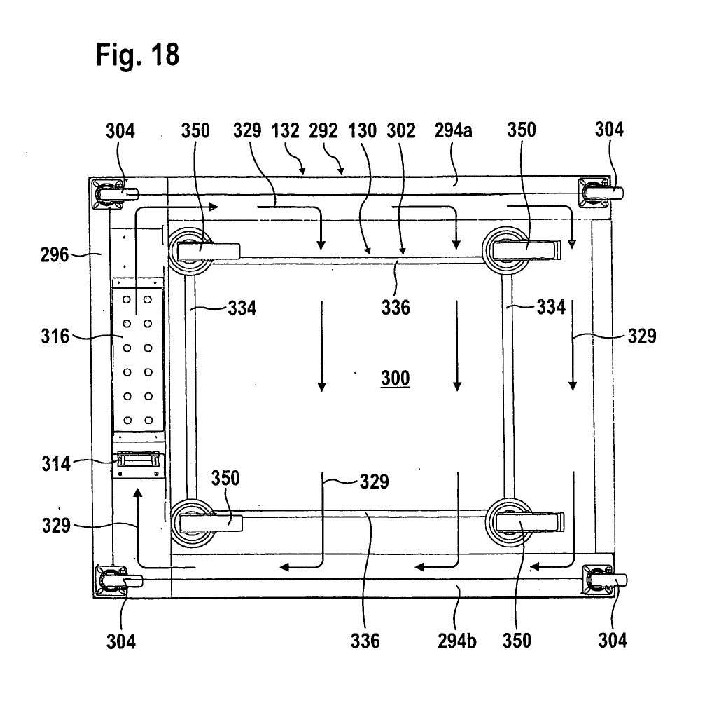

As may be seen from FIGS. 17 and 18, in which the circulating air flow is diagrammatically represented by the arrows 329, the cooled circulating air passes from the cooler 316 into the left side wall 294a, from there through the outlet openings 308 in the outlet-side air baffle 306 into the receiving space 300 and hence to the product to be cooled, which is suspended from the high rack trolley 130, from the receiving space 300 through the intake openings in the intake-side air baffle 319 into the right side wall 294b of the housing 292 of the high mobile cooling station 132 and, from there, back to the circulating-air fans 314, with the result that the circulating air circuit is closed.

By means of the cold-air curtain thus generated in the receiving space 300 the product to be cooled, which is suspended from the high rack trolley 130, is screened off from the warm environment.

The high rack trolley 130 inserted into the receiving space 300 is moreover screened off from the warmer surrounding area on four sides, namely on the left, at the rear, on the right and at the top, by means of the thermally insulated walls 294a, 294b, 296 and 298 of the housing 292 of the high mobile cooling station 132.

From the front of the high mobile cooling station 132, however, the high rack trolley 130 is freely accessible for the removal of cooled product by an operator, thereby allowing an ergonomic operation.

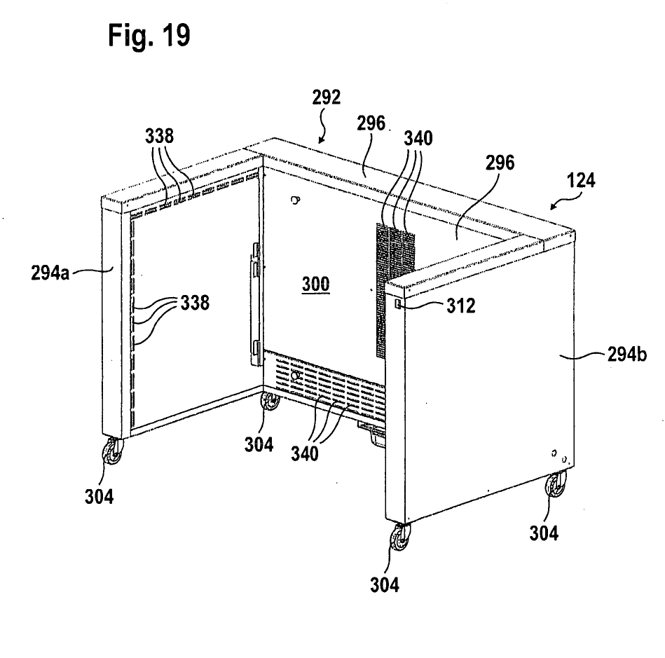

The low mobile cooling station 124 represented in FIGS. 19 to 21 differs from the high mobile cooling station 132 represented in FIGS. 13 to 18 in that it has no top wall, so that the low mobile cooling station 124 surrounds the low rack trolley 122 to be introduced into the receiving space 300 of the low mobile cooling station 124 only on three sides, namely on the left, on the right and at the rear, while the inserted rack trolley 122 is freely accessible at the front and at the top for the removal of cooled product by an operator.

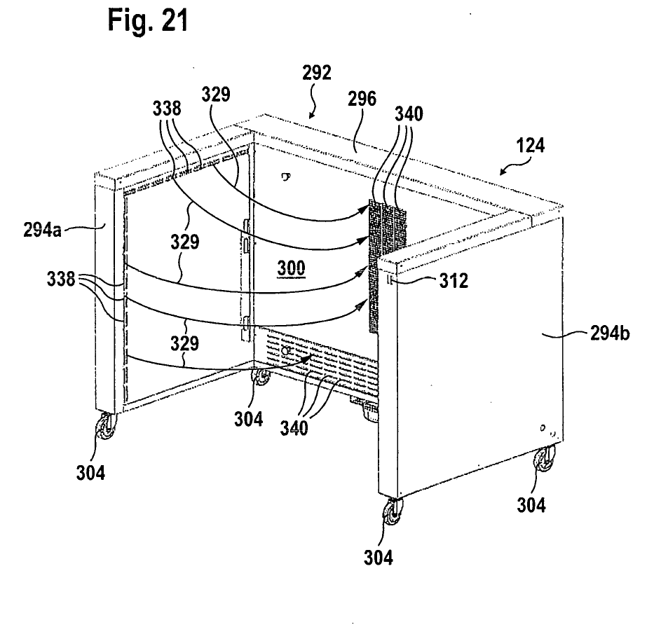

In the low mobile cooling station 124, moreover, the cooled circulating air is blown through outlet openings 338 in both side walls 294a and 294b into the receiving space 300 and hence, when the rack trolley 122 is inserted, onto the product to be cooled and is extracted from the receiving space 300 through intake openings 340 at the inside of the back wall 296 (see FIG. 21, in which the circulating air flow is diagrammatically represented by the arrows 329).

In the back wall 296 of the housing 292 of the low mobile cooling station 124 there are accordingly two circulating-air cooling devices each comprising circulating-air fans and a cooler, namely one circulating-air cooling device between the intake openings 340 and the outlet openings 338 of the left side wall 294a and one circulating-air cooling device between the intake openings 340 and the outlet openings 338 in the right side wall 294b.

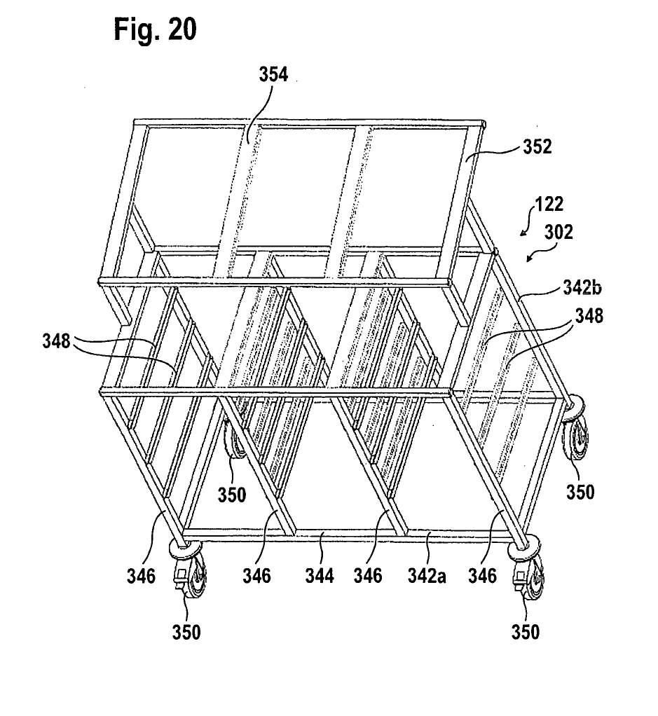

The low rack trolley 122 to be inserted into the low mobile cooling station 124 is represented individually in FIG. 20 and comprises a first frame 342a and a second frame 342b, which are each composed of two horizontal members 344 and four vertical members 346 connecting the horizontal members 344 to one another, as well as a multiplicity of suspension rails 348, which connect the first frame 342a and the second frame 342b to one another and lie opposite one another in each case in pairs and are used to suspend trays, food containers and/or drinks containers.

On its underside the rack trolley 122 is provided with four castors 350, by means of which the rack trolley 122 is movable over a floor.

On its upper side the rack trolley 122 carries a stand 352 comprising a lay-on frame 354 inclined relative to the horizontal for supporting trays, food containers and/or drinks containers in a position inclined relative to the horizontal, thereby facilitating the removal of cooled food and/or drinks from the containers supported on the lay-on frame 354.

Otherwise the low mobile cooling station 124 represented in FIGS. 19 to 21 is identical in construction and function to the high mobile cooling station 124 represented in FIGS. 13 to 18, to the previous description of which reference is made in this respect.

1. Cooling station for receiving a frame that has receivers for a product to be cooled,
wherein the cooling station comprises at least one fan for generating a circulating air flow through the frame and at least one cooler for cooling the circulating air flow and wherein the cooling station comprises a housing that surrounds a receiving space for receiving the frame on at least three sides.

2. Cooling station according to claim 1, wherein the cooling station is mobile.

3. Cooling station according to claim 1, wherein the cooling station is provided with castors.

4. Cooling station according to claim 1, wherein the housing of the cooling station surrounds the receiving space for receiving the frame on at least four sides.

5. Cooling station according to claim 1, wherein the cooling station has a switch, which, as the frame is introduced into the cooling station, automatically activates the generation of a cooled circulating air flow through the frame.

6. Cooling station according to claim 5, wherein the switch takes the form of a magnetically operated switch.

7. Cooling station according to claim 5, wherein the switch comprises a reed contact.

8. Cooling station according to claim 1, wherein the cooler takes the form of a heat exchanger which at the cold side contains a multiphase, flowable coolant.

9. Cooling station according to claim 8, wherein a device for allowing the coolant to circulate through the cooler is associated with the cooling station.

10. Cooling station according to claim 8, wherein the cooling station can be connected by at least one coolant line to an external coolant source and/or an external coolant sink.

11. Cooling station according to claim 10, wherein at least one coolant line is of a flexible design.

12. Cooling station according to claim 8, wherein the multiphase, flowable coolant is a binary ice.

13. Cooling station according to claim 1, wherein the cooling station has at least one outlet opening for blowing out cooled circulating air into the frame.

14. Cooling station according to claim 1, wherein the cooling station has at least one intake opening for taking in circulating air from the frame.

15. Combination of
a cooling station for receiving a frame that has receivers for a product to be cooled, wherein the cooling station comprises at least one fan for generating a circulating air flow through the frame and at least one cooler for cooling the circulating air flow and wherein the cooling station comprises a housing that surrounds a receiving space for receiving the frame on at least three sides, and
a frame, which has receivers for a product to be cooled and can be introduced in such a way into the receiving space of the cooling station that the cooling station surrounds the frame on at least three sides.

16. Combination according to claim 15, wherein the frame is mobile.

17. Combination according to claim 15, wherein the frame is provided with castors.

18. Combination according to claim 15, wherein the frame introduced into the receiving space of the cooling station is accessible on at least one side for the removal of cooled product from the receivers for the product to be cooled.

19. Combination according to claim 18, wherein the frame introduced into the receiving space of the cooling station is accessible on at least two sides for the removal of cooled product from the receivers for the product to be cooled.

20. Combination according to claim 15, wherein the receivers of the frame are designed to accommodate Gastronorm containers.

21. Combination according to claim 15, wherein the product to be cooled comprises food and/or drinks.

22. Combination according to claim 15, wherein the frame takes the form of a rack trolley.

23. Portioning system for a large-scale catering establishment, comprising at least one cooling station for receiving a frame that has receivers for a product to be cooled,
wherein the cooling station comprises at least one fan for generating a circulating air flow through the frame and at least one cooler for cooling the circulating air flow and wherein the cooling station comprises a housing that surrounds a receiving space for receiving the frame on at least three sides.

24. Portioning system according to claim 23, further comprising at least one frame, which has receivers for a product to be cooled and can be introduced in such a way into the receiving space of the cooling station that the cooling station surrounds the frame on at least three sides.
